(19) United States
(12) Patent Application Publication
(10) Pub. No.: US 2006/0186588 A1
(43) Pub. Date: Aug. 24, 2006

(54) Non-linear fiber/matrix architecture

(75) Inventor: Moreno J. White, Poway, CA (US)

Correspondence Address: STETINA BRUNDA GARRED & BRUCKER, 75 ENTERPRISE, SUITE 250, ALISO VIEJO, CA, 92656, US

(73) Assignee: Sparta, Inc.

(21) Appl. No.: 11/410,608

(22) Filed: Apr. 25, 2006

Related U.S. Application Data
(62) Division of application No. 10/976,556, filed on Oct. 29, 2004.
(60) Provisional application No. 60/520,067, filed on Nov. 14, 2003.

(51) Int. Cl. F16F 1/36

(52) U.S. Cl. 267/148; 267/149

(57) ABSTRACT

Provided is a composite spring assembly configured to provide non-linear stiffness in response to a load. The spring assembly comprises a body portion and a reinforcing element. The body portion defines a longitudinal axis along which the load may be placed. The reinforcing element is embedded in the body portion and is oriented in general disalignment with the longitudinal axis such that deformation of the body portion under the load causes the reinforcing element to move toward alignment with the load direction. The spring assembly may be provided as a prosthetic spine disc wherein the body portion is cylindrically shaped and has an outer wall and planar opposed body end faces. The reinforcing elements are cylindrically shaped and coaxially disposed relative to one another and to the outer wall. The spring assembly may be configured as an elongate tension band with the reinforcing element being configured as a continuous loop of material arranged in a double bowtie configuration.

### CROSS-REFERENCE TO RELATED APPLICATIONS

This application claims the benefit of U.S. Provisional Application No. 60/520,067, filed Nov. 14, 2003.

### STATEMENT RE: FEDERALLY SPONSORED RESEARCH/DEVELOPMENT

(Not Applicable)

### BACKGROUND OF THE INVENTION

The present invention relates generally to composite structures and, more particularly, to a uniquely configured fiber/matrix architecture for a composite structure that is specifically adapted to provide non-linear deformation in response to linear or non-linear loads. In this regard, the composite structure allows interconnected subcomponents the ability to function within their elastic range while simultaneously allowing for plastic or non-linear deformation in response to mechanical or thermo-mechanical loading. One embodiment of the invention is the composite structure which functions as a composite spring assembly allowing for exponentially or nonlinearly increasing resistance to loads as deformation or deflection of the composite spring assembly increases. Such non-linear deformation of the composite spring assembly is provided by off-axis orientation of fibers relative to an orientation of a primary load acting on the spring assembly.

There is currently known in the prior art, prostheses such as prosthetic spine discs and prosthetic limbs that are configured to restore some degree of physiological functioning to a patient requiring such prostheses. Prosthetic spine discs are typically designed as a replacement for degenerative discs of the spinal column in that they allow the patient to maintain normal or near normal physiological motion of a normal, healthy spinal column. Prosthetic limbs are artificial replacements for limbs lost through an accident or as a result of a birth defect. Prosthetic limbs provide the patient with the ability to engage in certain physical activities.

For example, lower limb prosthetics may provide an amputee the stability required to stand while further providing the ability for the amputee to engage in more rigorous physical activities such as walking and running. Lower limb prosthetic ankles designed for such rigorous physical activity must possess certain dynamic properties that allow the amputee to mimic the stride or gait of a non-amputee. In this regard, such lower limb prosthetics may include load bearing members such as a rotation enabling member surrounded by tension bands. Both load bearing members (i.e., the rotation enabling member and the tension bands) are configured to provide an elastic response during the gait. The prosthetic ankle may be shaped in an hourglass configuration and may transfer compression loading while allowing for rotation thereof.

The tension bands of such lower limb prosthetic ankles may provide tensile loading resistance to the prosthetic ankle such that proper rotation dynamics are provided during use. More particularly, it has been determined that such tension bands are preferably configured to have a non-linear stiffness in order to match gait parameters of a non-amputee. In this regard, the tension bands preferably will exhibit relatively little resistance along a longitudinal axis upon initial tension loading of the tension band. However, such tension bands will preferably provide exponentially increasing resistance along the longitudinal axis as deflection (i.e., stretching) of the tension band increases.

In regards to prosthetic spine discs as a replacement for degenerative discs of the spinal column, it is likewise preferable that the prosthetic spine disc approximate the force/deformation response of normal discs while maintaining functionality during extended repetitive loading over the lifetime of the patient. More specifically, it is preferable that the prosthetic spine disc will exhibit a controlled resistance along a longitudinal axis generally defined by the spinal column upon initial compression loading of the prosthetic spine disc. However, such prosthetic spine disc will preferably provide exponentially increasing resistance along the longitudinal axis as deflection (i.e., axial compression) of the prosthetic spine disc increases.

As can be seen, there exists a need in the art for a composite spring assembly capable of providing controlled non-linear resistance to loads as deformation (i.e., stretching or compression) of the spring assembly increases. In addition, there exists a need in the art for a composite spring assembly capable of withstanding degenerative effects of extended repetitive cycles. Furthermore, there exists a need in the art for a composite spring assembly (such as a tension band for a lower limb prosthetic ankle or a prosthetic spine disc for a spinal column) that is easily tailorable such that the load/deformation response thereof is compatible with a given set of physiological characteristics (e.g., gait parameters) of a particular patient.

### BRIEF SUMMARY OF THE INVENTION

The present invention comprises a composite spring assembly having a uniquely configured fiber/matrix architecture that is adapted to provide non-linear or exponentially increasing resistance to loads as deformation or deflection of the spring assembly increases. Reinforcing elements of the spring assembly are initially arranged off-axis to the direction of major loads such that non-linear stiffness of the composite spring assembly is provided. The reinforcing element is embedded in a body portion which may generally be comprised of matrix material such as polymer resin matrix.

The matrix material preferably has a low modulus of elasticity such that, as load is applied to the composite spring assembly, the deformation of the spring assembly tends to align the reinforcing element with the direction of applied load such that the matrix material is placed in local tension and/or compression along a length of the reinforcing element. As load is further applied, the reinforcing element eventually becomes substantially aligned with the direction of the load at which point the reinforcing element resists substantially the entire load after which the spring assembly becomes substantially stiffer as compared to the stiffness in the undeformed condition.

The reinforcing element may be comprised of a fiber bundle made up of tow which is typically comprised of a plurality of synthetic filaments provided in a unidirectional configuration. However, the reinforcing element may be provided in any conventional form, such as unidirectional tow, woven fabric, knitted fabric, swirl mat, felt mat, wound, or braided, etc. A small amount of matrix material may be infused into or applied to the tow to hold the filaments in place and to maintain the shape of the tow in a mold prior to embedding the tow within the body portion. The composite spring assembly may be provided in any number of alternative configurations including, but not limited to, a tension band such as may be used in a prosthetic ankle, or a prosthetic spine disc such as may be used as a replacement for a degenerative disc of a spinal column.

### BRIEF DESCRIPTION OF THE DRAWINGS

FIG. 1 is a perspective view of a tension band in its undeformed condition and illustrating a reinforcing element in a shaped configuration and disposed in a body portion of the tension band;

FIG. 2 is a perspective view of the tension band in its deformed condition and illustrating the reinforcing element in a straightened orientation;

FIG. 3 is a side view of a prosthetic spine disc in its undeformed condition and illustrating a circumferentially oriented pair of the reinforcing elements disposed in the body portion of the prosthetic spine disc;

FIG. 4 is a cross-sectional view of the prosthetic spine disc taken along line 4-4 of FIG. 3 and illustrating a core element and the reinforcing elements disposed in the body portion; and

FIG. 5 is a cross-sectional view of a fiber bundle illustrating an arrangement of filaments disposed within a bundle matrix.

### DETAILED DESCRIPTION OF THE INVENTION

Referring now to the drawings wherein the showings are for purposes of illustrating the present invention only, and not for purposes of limiting the same, the subject invention is a composite structure which may be embodied as a composite spring assembly 10 allowing for exponentially or nonlinearly increasing resistance to loads as deformation or deflection of the composite spring assembly increases. The composite spring assembly 10 has a uniquely configured fiber/matrix architecture that is adapted to provide non-linear or exponentially increasing resistance to loads as deformation or deflection of the spring assembly 10 increases. Contrary to current practices in the art of composite construction wherein reinforcing elements 26 are generally initially aligned in the direction of major forces or loads, reinforcing elements 26 of the spring assembly 10 are initially arranged off-axis to the direction of major loads such that non-linear stiffness of the composite spring assembly 10 is provided.

In the spring assembly 10 of the present invention, the reinforcing element 26 is embedded in a body portion 14. The body portion 14 may generally be comprised of matrix material 38 such as polymer resin matrix although it is contemplated that non-polymer matrix materials 38 may be utilized. The matrix material 38 preferably has a low modulus of elasticity such that, as load is applied to the composite spring assembly 10, the deformation of the spring assembly 10 tends to align the reinforcing element 26 with the direction of applied load such that the matrix material 38 is placed in local tension and/or compression along a length of the reinforcing element 26. The degree of movement of the reinforcing element 26 is dependent upon the original or undeformed shape of the reinforcing element 26 and the resistance provided by the matrix against the tendency of the in-situ reinforcing element 26 to align in response to the applied load.

As load is further applied, the reinforcing element 26 becomes increasingly aligned with the direction of the load until becoming substantially aligned with the direction of the load at which point the reinforcing element 26 resists substantially the entire load. At this point, the spring assembly 10 becomes substantially stiffer as compared to the stiffness in the undeformed condition. In this regard, the stiffness characteristics of the spring assembly 10 may be controlled by altering the stiffness (i.e., the modulus of elasticity) of the matrix material 38 in which the reinforcing element 26 is embedded. Furthermore, a predetermined or desired stiffness characteristic and overall load carrying capability of the spring assembly 10 may be provided by altering the in-situ architecture or shape of the reinforcing elements 26 as embedded in the matrix material 38. More specifically, significant non-linearity in load versus deformation of the spring assembly 10 may be achieved by controlling the degree to which the reinforcing element 26 is arranged off-axis with respect to the direction of the load, as will be described in greater detail below.

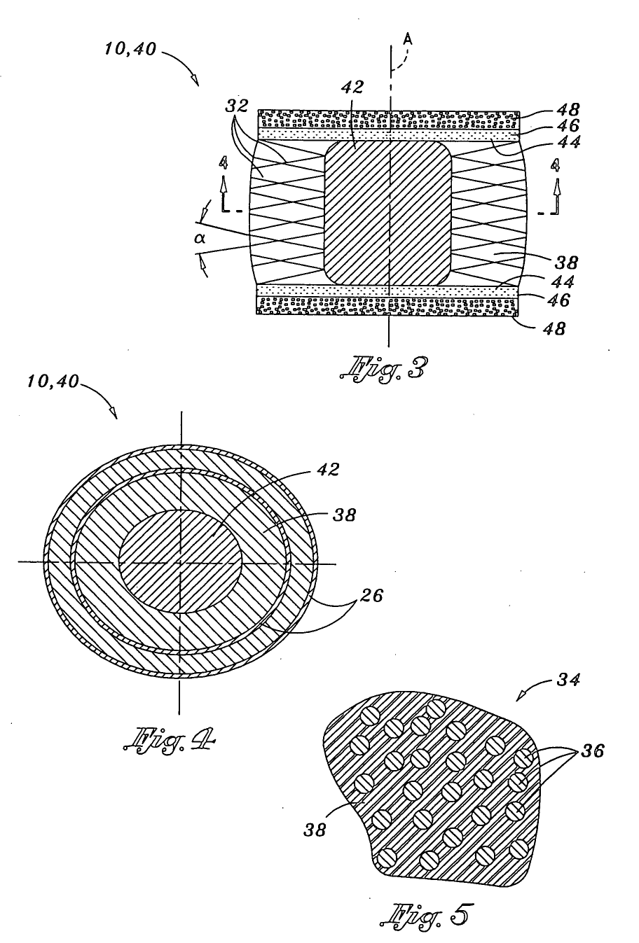

The reinforcing element 26 may be comprised of a fiber bundle 34 made up of tow 32. Tow 32 is typically comprised of a large number of synthetic continuous filaments 36 or monofilaments collected in ropelike form. The filaments 36 may be provided in a unidirectional or untwisted configuration such that the filaments 36 are arranged in a generally parallel manner relative to one another. However, it is contemplated that the reinforcing element 26 may be provided in any conventional form, such as woven fabric, knitted fabric, swirl mat, felt mat, wound, or braided, etc. If provided as fabric, the reinforcing element 26 may be used in a prosthetic spine disc 40 as will be described in greater detail below and as is shown in FIGS. 3 and 4. In a fabric configuration, the tows 32 may be interwoven such that a set of substantially parallel tows 32 are arranged at a specified angle α to another set of parallel tows 32, as shown in FIGS. 3 and 4. The relative angle α between the sets of parallel tows 32 is typically based on the desired directional strength and stiffness characteristics of the spring assembly 10.

For example, in the prosthetic spine disc 40 shown in FIGS. 3 and 4, the sets of parallel tows 32 are interwoven or placed as non-woven uni-directional tape or woven tows 32 which are themselves woven (such as a braided tow). In this regard, the sets of parallel tows 32 are at a shallow angle α relative to each other. As compressive load is applied to the prosthetic spine disc 40, gradual radial displacement of the body portion 14 results in gradual circumferential orientation of individual ones of the tows 32 in the circumferentially oriented reinforcing elements 26. As the compressive load is further applied, the angle α between the sets of tow 32 becomes increasingly smaller such that eventually each tow 32 in each one of the sets is substantially circumferentially aligned at which point the tows 32 resists substantially all hoop load. At this point, the prosthetic spine disc 40 becomes substantially stiffer as compared to the stiffness in its undeformed condition. The stiffness characteristics of the spring assembly 10 may be controlled by altering the modulus of elasticity of the matrix material 38 as well as by altering the in-situ architecture of the sets of tow 32 embedded in the matrix material 38 or by the type or quantity of filament 36 (i.e. fiber) selected.

Each tow 32 may comprise, for example, 1000, 3000, 6000, 12000, 24000, 48000, 56000 or 125000 filaments 36. However, any number of filaments 36 may make up the tow 32. The tows 32 may be held in position by cross stitches (not shown). However, a small amount of matrix material 38 such as thermoplastic resin may be infused into or applied to the tow 32 to hold the filaments 36 in place relative to each other in a manner that will be descried in greater detail below. In addition, the infused or applied matrix material 38 may be used to maintain the overall configuration or shape of the tow 32 in a mold of the body portion 14 prior to embedding the tow 32 within the body portion 14 using the matrix material 38.

If the reinforcing element 26 is configured as tow 32 or fiber bundle 34 wherein filaments 36 of the tow 32 are held together with a matrix material 38 such as resin, the filaments 36 may be provided with a specific tow 32 packing. Referring to FIG. 5, the tow packing of the fiber bundle 34 may be defined as the percentage by cross-sectional area of filaments 36 within an overall cross-sectional area of the tow 32. For example, a tow packing ratio, also referred to as fiber volume fraction, of about 30% or about 60% may be preferred wherein the spring assembly 10 is configured as a tension band 12 for a prosthetic ankle, as will be described in greater detail below. Regarding material from which the reinforcing element 26 may be comprised, it is contemplated that the filaments 36 may be glass, quartz, carbon, graphite, metallic or organic such as KEVLAR brand polyamide and the like.

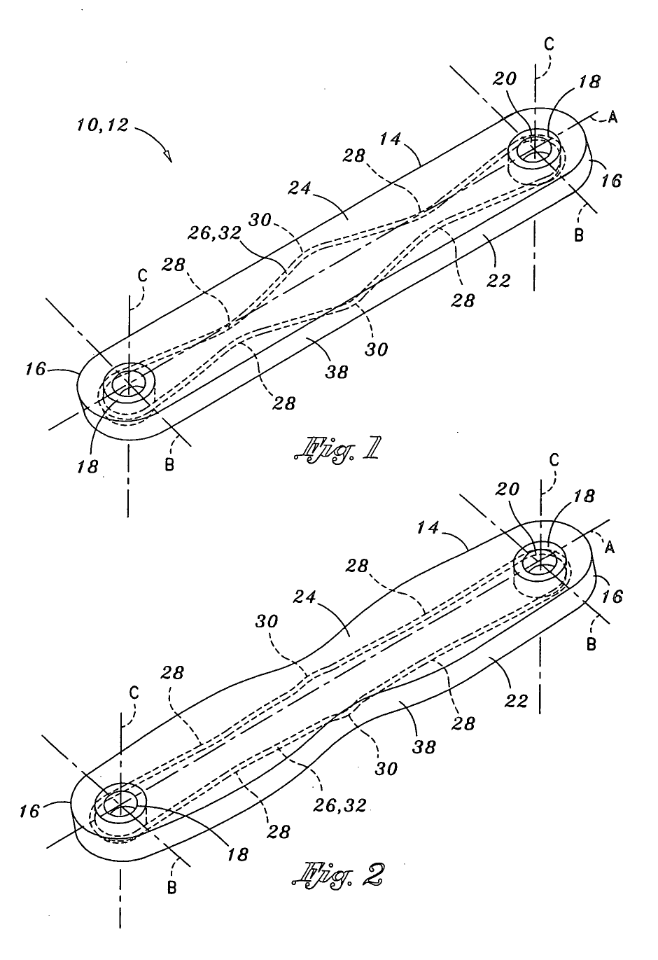

The composite spring assembly 10 may be provided in any number of alternative configurations including, but not limited to, the tension band 12 such as may be used in the prosthetic ankle and as is shown in FIGS. 1 and 2, or a prosthetic spine disc 40 which may be used as a replacement for a degenerative disc of a spinal column and as is shown in FIGS. 3 and 4. Referring to FIGS. 1 and 2, shown is the spring assembly 10 configured as the tension band 12 in its respective undeformed and deformed conditions. Also illustrated is the reinforcing element 26 disposed within a body portion 14 of the tension band 12. As was mentioned earlier in regards to the composite spring assembly 10, the body portion 14 of the tension band 12 is fabricated from matrix material 38 such as polymer resin matrix although non-polymer matrix materials 38 may be utilized.

The matrix material 38 preferably has a low modulus of elasticity and a high strain to failure ratio. As can be seen in FIGS. 1 and 2, the body portion 14 defines opposing ends 16 to define a length of the tension band 12. A longitudinal axis A extends between the opposing ends 16. The tension band 12 has generally planar and substantially parallel opposing lateral sides 22 defining a thickness of the body portion 14. Planar and substantially parallel opposing faces 24 may be oriented to be generally orthogonally to the sides 22. The faces 24 define a width of the body portion 14 as shown in FIGS. 1 and 2. It should be noted that the tension band 12 is not limited to the generally parallel configuration shown in FIGS. 1 and 2.

In this regard, it is contemplated that to achieve certain load bearing and deformation characteristics, it may be desirable that the tension band 12 may be configured such that the width is arranged in a tapered configuration along the length of the tension band 12 wherein the cross-sectional area at one of the ends 16 is relatively greater than that at the opposing one of the ends 16. The tension band 12 may also be configured such that the width tapers from opposing ends 16 to an approximate midpoint along the length of the body portion 14. Furthermore, the tension band 12 may be configured to be asymmetrically configured about the longitudinal axis A instead of the symmetrical configuration shown in FIGS. 1 and 2. Further in this regard, it may be emphasized that a critical feature of the tension band 12, as well as any other configuration of the spring assembly 10, is the interaction of the matrix material 38 in the body portion 14 with the reinforcing element 26 embedded therewithin. Thus, the specific geometry, size, shape, material (i.e., mechanical properties), and relative disposition of the body portion 14 and reinforcing element 26, acting both alone and in combination, is critical in providing a predetermined load versus deformation characteristic of the spring assembly 10 as may be embodied in the tension band 12 and the prosthetic spine disc 40.

In the configuration shown in FIGS. 1 and 2, the body portion 14 has a generally rectangular cross sectional shape although it is contemplated that the body portion 14 may be configured to have any number of cross sectional shapes including, but not limited to, elliptical, circular and various other geometric shapes. Each one of the ends 16 has a generally rounded shape with a bore 20 being formed therethrough and extending between the opposing faces 24. Each one of the bores 20 defines a bore axis C oriented generally orthogonally to the longitudinal axis A. As an aid in describing the functional mechanics of the tension band, a transverse axis B is defined as being orthogonally oriented relative to both the longitudinal axis A and the bore axes C. The bores 20 provide a means for attaching the ends 16 of the tension band 12 to the prosthetic device and therefore provide the means by which loads may be transferred into the tension band 12.

Optionally, an eyelet, bushing 18 or other suitable device may be included in the body portion 14 to aid in distributing the load from the prosthetic into the body portion 14 in a substantially uniform manner. The bushing, if included, may extend between opposing ones of the faces 24. However, the bushing 18 may extend beyond both or either one of the faces 24 or only within a portion of the thickness of the body portion 14. The bore 20 may be formed through the bushing 18 in the manner illustrated in FIGS. 1 and 2. However, it is contemplated that the tension band 12 may be secured to the prosthetic using alternative means other than the bores 20. For example, the ends 16 of the tension band 12 may be provided with keyed features that are compatible with mating receiving features in the prosthetic to which the tension band 12 is to be secured.

Importantly, in the tension band 12 of FIGS. 1 and 2, it has been determined that a preferable arrangement of the reinforcing element 26 is in a “double bowtie” configuration wherein substantially no portion of the reinforcing element 26 is aligned with the longitudinal axis A, as can be seen in FIGS. 1 and 2. As was earlier mentioned, the reinforcing element 26 is disposed in the body portion 14 approximately midway between the faces 24 of the body portion 14. In addition, it can be seen that the reinforcing element 26 is configured to be substantially symmetrical about the longitudinal axis A as well as symmetrical about a midpoint along the length of the body portion 14. However, asymmetrical shapes and configuration of the reinforcing element 26 may be used depending of the desired stiffness characteristics of the tension band 12. Furthermore, although a singular one of the reinforcing element 26 is shown disposed within the tension band 12, it should be noted that multiple ones of the reinforcing elements 26 may be provided in the body portion 14 in any spacing and in similar of varying configurations or shapes.

Regarding the specific shape of the reinforcing element 26 wherein the tension band 12 length, width and thickness are approximately and respectively 2¾, ⅝ and 1/4 inches, it has been determined that the double bowtie shape provides approximately 0.1 inches of defection at about 1000 pounds of tensile load. The double bowtie shape as shown in FIGS. 1 and 2 may be described as a continuous length of material extending about each one of the ends 16 in substantially close proximity to respective ones of the bore 20 or bushing 18, if included. Extending from each one of the ends 16 toward one another, the reinforcing element 26 tapers inwardly toward the longitudinal axis A. Moving in a direction from each one of the ends 16 to the midpoint of the length of the body portion 14, the reinforcing element 26 tapers back outwardly away from the longitudinal axis A until it joins the reinforcing element 26 extending from the opposing one of the ends 16.

Not including portions of the reinforcing element 26 that extend about respective ones of the bores 20, a total of six bends are provided in the double bowtie shape. At each bend, a radius is provided in the reinforcing element 26 to enhance the deformation characteristics of the tension band 12 when in the deformed shape, shown in FIG. 2. Advantageously, for the given application, the double bowtie shape may provide the lowest material strains while simultaneously providing the greatest amount of non-linearity of load versus deformation as compared to other configurations of the reinforcing element 26. However, it should be noted that there are an infinite number of alternative configurations for the reinforcing element 26. For example, for certain applications, it may be desirable to provide the reinforcing element 26 with greater or fewer bends in order to achieve a desired load versus deformation characteristic.

The operation of the tension band is described with reference to FIGS. 1 and 2 showing the tension band 12 in its respective undeformed and deformed condition and illustrating the corresponding undeformed and deformed condition of the reinforcing element. As load is applied to the tension band 12, the deformation (i.e., stretching) of the tension band 12 tends to align the reinforcing element 26 with the direction of applied tensile load such that the matrix material 38 is placed in local tension and compression acting parallel to the transverse axis B along the length of the tension band 12. As can be seen in FIG. 2, at a se of first bends 28 in the reinforcing element, the stretching results in local tension force acting to separate the reinforcing elements 26 at a set of the first bends 28 adjacent each one of the bores 20. Simultaneously, the stretching results also results in local compression forces acting parallel to the transverse axis B at a set of second bends 30 located adjacent the approximate midpoint of the body portion 14.

As load is further applied, the reinforcing element 26 becomes increasingly aligned with the longitudinal axis A such that the reinforcing element 26 is eventually substantially aligned with the direction of the load. Once substantial alignment of the reinforcing element 26 is achieved, the reinforcing element 26 resists substantially the entire load. At this point, the tension band 12 becomes substantially stiffer in the deformed condition as compared to the stiffness in the undeformed condition. As may be appreciated, the stiffness characteristics of the tension band 12 may be controlled by altering the stiffness (i.e., the modulus of elasticity) of the matrix material 38 in which the reinforcing element 26 is embedded. Furthermore, a desired stiffness characteristic and overall load carrying capability of the tension band 12 may be provided by altering the in-situ shape of the reinforcing element 26 within the matrix material 38.

Referring now to FIGS. 3 and 4, shown is the prosthetic spine disc 40 in its undeformed condition and illustrating a generally cylindrically shaped and circumferentially oriented pair of the reinforcing elements 26 disposed in the body portion 14. The body portion 14 is shown having a general disc shape or puck like configuration with a cylindrical outer wall and substantially planar opposed generally parallel body end faces 44. However, the body portion 14 may be configured in a variety of alternative shapes and sizes. FIG. 4 illustrates a nucleus or core element 42 generally concentrically disposed within the pair of the reinforcing elements 26. As can be seen in FIG. 3, the pair of the reinforcing elements 26 are concentrically disposed within the body portion 14 although it is contemplated that the reinforcing elements 26 may be provided in any number of concentrically or otherwise arranged sets of reinforcing elements 26. The body portion 14 is made up of matrix material 38 similar to that described above for the spring assembly 10 and for the tension band 12.

The fibers (i.e., tow) that make up the reinforcing element 26 are fabricated off-axis to the circumferential direction. As was earlier mentioned, the tows 32 may be interwoven such that a set of substantially parallel tows 32 are arranged at a specified angle α to another set of parallel tows 32. The relative angle α between the sets of parallel tows 32 is typically based on the desired directional strength and stiffness characteristics of the spring assembly 10. For example, the sets of parallel tows 32 may be interwoven or placed as non-woven uni-directional tape or woven tows 32 which are themselves woven (such as a braided tow). In this regard, the sets of parallel tows 32 are at a shallow angle α relative to each other as can be seen in FIG. 3.

Optionally, the core element 42, shown having a general cylindrical shape, may be substantially concentrically disposed within the body portion 14 and extending between the opposing ones of the body end faces 44. However, the core element 42 may be configured in a number of alternative shapes and sized including, but not limited to, spherical, rectangular, or disc shaped. The core element 42, if included, may be fabricated of polymeric matrix material 38 similar to that used in the body portion 14. However, the modulus of elasticity of the core element 42 may be higher (i.e., more stiff) or lower (i.e., less stiff) than that of the body portion 14 in order to radially distribute compressive load through the prosthetic spine disc 40.

The core element 42, defines the body portion 14 as an annular configuration to mimic the configuration of a normal, healthy human vertebra. The core element 42 could be a biocompatible polymer or it could have a similar design to the annulus fibroses incorporating off-angle nominally circumferentially-oriented reinforcing elements 26 (i.e., fibers) which may provide increasing stiffness to the core element 42 as the core element 42 is compressed. The reinforcing elements 26 may limit radial expansion thereof as the fibers of the reinforcing elements 26 carry increasingly greater load. In this regard, the reinforcing element/material matrix architecture of the prosthetic spine disc 40 may be easily tailored to approximate the force/deformation response of a normal, healthy human vertebra while maintaining its function over the lifetime of the patient.

Attached to each one of the body end faces is a disc shaped interface plate 46 having substantially the same diameter as that of the body portion 14 although other shapes and sizes are contemplated. Attached to each one of the interface plates 46 may be the external component 48 such as adjacent (i.e., inferior and superior) vertebrae. The interface plates 46 may have a porous surface to allow in-growth of bone material of the living adjacent vertebrae. Alternatively, the interface plate 46 may incorporate small anchors forming a mechanical lock in order to secure the plates to the adjacent vertebrae. A preferred material for the interface plates 46 is a biocompatible matrix material, such as carbon/polyetheretherketone (PEEK), to enhance post operative imaging of a junction between the prosthetic spine disc 40 and the living adjacent vertebrae which may be otherwise inhibited if the prosthetic spine disc 40 were fabricated of metallic material. The use of a biocompatible matrix material 38 in the interface plate 46 may further promote compliance of the prosthetic spine disc 40 with the inferior and superior vertebra.

Regarding its operation and referring still to FIGS. 3 and 4, the reinforcing elements 26 in the prosthetic spine disc 40 are preferably significantly stiffer than the stiffness of the matrix material 38 of the body portion 14. As the prosthetic spine disc 40 is compressed, the fibers of the reinforcing elements 26 become more circumferentially or hoop orientated and therefore may provide increasing circumferential (hoop) load resistance by carrying a greater percentage of the hoop load. This increase in the hoop load resistance significantly increases the apparent compression stiffness of the prosthetic spine disc 40. It is also be possible to tune the prosthetic spine disc 40 architecture to limit deflection of the prosthetic spine disc 40 below an elastic fatigue limit of the matrix material 38 and the reinforcing element 26 which, in theory, may eliminate premature fatigue failure of the prosthetic spine disc 40.

Regarding a process or method of manufacturing the composite spring assembly 10 in any configuration including, but not limited to, the above-described tension band 12 and the prosthetic spine disc 40, the reinforcing element 26 is wrapped around a preform. As was earlier mentioned, the reinforcing element 26 may be provided in a variety of alternative shapes, sizes, configurations and materials depending on the particular application or embodiment of the spring assembly 10. For example, in the tension band 12, the reinforcing element 26 may be configured as a fiber bundle 34. After wrapping around a preform, the reinforcing element 26 may be infused with a matrix material 38 such as those described above. Once infused, the matrix material 38 is allowed to cure.

After the matrix material 38 reaches a predetermined set or stiffness, the matrix-infused reinforcing element 26 is placed into a spring assembly 10 mold having a configuration substantially matching that of a completed component. Rigidity of the cured matrix-infused reinforcing element 26 maintains the shape of the reinforcing element 26 in the spring mold as the matrix material 38 is introduced into the spring assembly 10 mold. After the matrix material 38 of the spring assembly 10 mold has set or cured sufficiently, the spring assembly 10 may be demolded. Flash, if any, may be trimmed from the composite spring assembly 10. Post-processing, such as forming attachment holes or features in the demolded composite spring assembly 10, may then be performed.

1. A composite spring assembly configured to provide non-linear stiffness in response to a load, the composite spring assembly comprising:
a body portion defining a longitudinal axis;
at least one reinforcing element embedded in the body portion and oriented in general disalignment with the longitudinal axis such that deformation of the body portion under the load causes the reinforcing element to move toward alignment with the load direction.

2. The composite spring assembly of claim 1 wherein the body portion is formed of a polymer resin matrix material.

3. The composite spring assembly of claim 1 wherein the reinforcing element is comprised of a fiber bundle.

4. The composite spring assembly of claim 1 wherein the fiber bundle is comprised of a plurality of synthetic continuous filaments disposed in parallel relationship to one another.

5. The composite spring assembly of claim 4 wherein the fiber bundle includes from about 1000 to about 125000 filaments.

6. The composite spring assembly of claim 4 wherein the filaments are held in position by cross stitches.

7. The composite spring assembly of claim 1 wherein the reinforcing element is provided as fabric.

8. The composite spring assembly of claim 1 wherein the reinforcing element is comprised of glass.

9. The composite spring assembly of claim 1 wherein the reinforcing element is comprised of quartz.

10. The composite spring assembly of claim 1 wherein the reinforcing element is comprised of carbon.

11. The composite spring assembly of claim 1 wherein the reinforcing element is comprised of graphite.

12. The composite spring assembly of claim 1 wherein the reinforcing element is comprised of metallic material.

13. The composite spring assembly of claim 1 wherein the reinforcing element is comprised of organic material.

14. (canceled)

15. (canceled)

16. (canceled)

17. (canceled)

18. (canceled)

19. (canceled)

20. The composite spring assembly of claim 1 wherein:
the body portion is configured as an elongate tension band defining a length having a midpoint and having opposing ends with the longitudinal axis extending therebetween;
the reinforcing element being configured as a continuous loop of material disposed along the length and arranged in a double bowtie configuration wherein the reinforcing element extends about each one of the ends and tapering inwardly toward the longitudinal axis along a direction from the ends toward the midpoint, and tapering back outwardly away from the longitudinal axis and joining the reinforcing element extending from the opposing one of the ends at the midpoint such that substantially no portion of the reinforcing element is aligned with the longitudinal axis.

21. (canceled)

22. (canceled)
